(19) United States
(12) Patent Application Publication
(10) Pub. No.: US 2026/0030896 A1
(43) Pub. Date: Jan. 29, 2026

(54) METHOD OF MONITORING A REAR AREA BEHIND A VEHICLE AND A VEHICLE USING THE SAME

(71) Applicants: HYUNDAI MOTOR COMPANY, Seoul (KR); KIA CORPORATION, Seoul (KR)

(72) Inventors: Byoungcheol Jeong, Hwaseong-si (KR); Jongyoung Lee, Hwaseong-si (KR); Seungmin Kim, Hwaseong-si (KR)

(73) Assignees: HYUNDAI MOTOR COMPANY, Seoul (KR); KIA CORPORATION, Seoul (KR)

(21) Appl. No.: 18/967,581

(22) Filed: Dec. 3, 2024

(30) Foreign Application Priority Data
Jul. 23, 2024 (KR) 10-2024-0097372

(51) Int. Cl. G06V 20/56

(52) U.S. Cl. CPC G06V 20/56

(57) ABSTRACT

A vehicle includes: a rear door configured to open and close a rear part of the vehicle; a gear switch implemented for manipulating a gear shift of the vehicle; a built-in camera disposed on a frame supporting the rear door and implemented to capture a rear view behind the vehicle; an in-vehicle infotainment (IVI) system configured to receive an image signal acquired by capturing the rear view behind the vehicle from the built-in camera, based on at least one of a state of a shift range indicated by the gear switch and an open or closed state of the rear door when a rear view mode is on; and a display device displaying a rear image signal provided from the IVI system. The rear view mode is an operation mode where the IVI system provides a rear view image of the vehicle.

### CROSS-REFERENCE TO RELATED APPLICATION

This application claims priority to and the benefit of Korean Patent Application No. 10-2024-0097372 filed in the Korean Intellectual Property Office on Jul. 23, 2024, the entire contents of which are incorporated herein by reference.

### BACKGROUND

### (a) Technical Field

The present disclosure relates to a method for monitoring a view of the rear area behind a vehicle and to a vehicle using the same.

### (b) Description of the Related Art

A special vehicle, such as a delivery vehicle, a refrigerated/freezer truck, or a police operation vehicle, may include a door disposed at the rear of the vehicle to open and close a rear part or space of the vehicle. For example, a rear door of the special vehicle may be implemented as a twin swinging door type, i.e., a twin swing door. In a twin swing door, a rear camera of the vehicle may be disposed near the handle or license lamp of the twin swing door. The rear camera may provide a rear view of the vehicle. However, the rear camera is unable to provide the rear view if the vehicle reverses while the twin swing door is opened, depending on a purpose of the special vehicle.

### SUMMARY

The present disclosure provides a method for monitoring the rear of a rear door type vehicle for providing a rear view behind the vehicle and a vehicle of the rear door type that uses the same.

According to an example embodiment, a vehicle includes: a rear door disposed at the rear of the vehicle; a gear switch implemented for manipulating a gear shift of the vehicle; a built-in camera disposed on a frame supporting the rear door and implemented to capture a rear view behind the vehicle; an in-vehicle infotainment (IVI) system determining to or configured to receive an image signal acquired by capturing the rear view of the vehicle from the built-in camera, based on at least one of a state of a shift range indicated by the gear switch and an open or closed state of the rear door when a rear view mode is on; and a display device displaying a rear image signal provided from the IVI system.

The rear view mode may be an operation mode where the IVI system provides a rear view image of the vehicle.

In a reverse open state in which the rear view mode is on, the gear switch indicates the shift range in reverse, and the rear door is opened, the IVI system may receive the image signal acquired by capturing the rear view of the vehicle from the built-in camera and may generate the rear image signal by using the image signal.

The vehicle may further include a rear camera disposed at the rear door. In the reverse open state, the IVI system may request the built-in camera instead of the rear camera to transmit the image signal. In the reverse open state, the built-in camera may capture the rear view of the vehicle in response to the request to generate the image signal and may transmit the generated image signal to the IVI system.

In a rear monitor state in which the rear view mode is on, the gear switch indicates the shift range is in a park or neutral gear, and the rear door is opened, the IVI system may receive the image signal acquired by capturing the rear view of the vehicle from the built-in camera and may generate the rear image signal by using the image signal.

The vehicle may further include a communication device configured to receive the rear image signal from the IVI system and to transmit the rear image signal to a personal terminal of a vehicle driver.

When the rear view mode is on and the gear switch indicates the shift range in reverse, the IVI system may receive the image signal acquired by capturing the rear view of the vehicle from the built-in camera and may generate the rear image signal by using the image signal.

The vehicle may further include a center fascia including a switch for controlling the rear view mode.

According to another embodiment, a method is provided for monitoring the rear of a vehicle by an in-vehicle infotainment (IVI) system of the vehicle. The method includes: transmitting, by a center fascia of the vehicle, a mode control signal to the IVI system indicating that a rear view mode is on. The method also includes transmitting, by a door detection sensor, a door opening/closing signal to the IVI system by detecting that a rear door of the vehicle is opened. The method also includes transmitting, by a gear switch of the vehicle, a gear signal to the IVI system indicating a shift range in reverse. The method also includes detecting, by the IVI system, a reverse open state in which the vehicle reverses while the rear door is opened under a condition that the rear view mode is on, based on the mode control signal, the gear signal, and the door opening/closing signal. The method also includes requesting, by the IVI system, a built-in camera of the vehicle to transmit an image signal when the reverse open state is detected. The method also includes generating, by the built-in camera of the vehicle, the image signal indicating an image acquired by capturing a rear view of the vehicle in response to the request and transmitting the generated image signal to the IVI system.

The method may further include receiving, by the IVI system, the image signal and converting the received image signal into a rear image signal by image-processing the signal. The method also includes displaying, by a display device of the vehicle, the rear image signal.

According to still another embodiment, a method is provided for monitoring the rear of a vehicle by an in-vehicle infotainment (IVI) system of the vehicle. The method includes transmitting, by a center fascia of the vehicle, a mode control signal to the IVI system indicating that a rear view mode is on. The method also includes transmitting, by a door detection sensor, a door opening/closing signal to the IVI system by detecting that a rear door of the vehicle is opened. The method also includes transmitting, by a gear switch of the vehicle, a gear signal to the IVI system indicating a shift range in a park gear. The method also includes detecting, by the IVI system, a rear monitor state in which the vehicle is parked while the rear door is opened under a condition that the rear view mode is on, based on the mode control signal, the gear signal, and the door opening/closing signal. The method also includes requesting, by the IVI system, a built-in camera of the vehicle to transmit an image signal when the rear monitor state is detected. The method also includes generating, by the built-in camera of the vehicle, the image signal indicating an image acquired by capturing a rear view of the vehicle in response to the request and transmitting the generated image signal to the IVI system.

The method may further include receiving, by the IVI system, the image signal and converting the received image signal into a rear image signal by image-processing the signal. The method also includes transmitting, by a communication device of the vehicle, the rear image signal to a personal terminal of a vehicle driver.

The vehicle according to the present disclosure may acquire the rear view image of a vehicle of the rear door type by using the built-in camera and may provide the same to the driver regardless of the state of the rear door.

### BRIEF DESCRIPTION OF THE DRAWINGS

FIG. 1 shows a side perspective view of a vehicle and a rear view of the vehicle according to an example embodiment.

FIG. 2 is a view showing a configuration of a vehicle according to an example embodiment.

FIG. 3 is a flowchart showing a method of providing a rear image by an in-vehicle infotainment (IVI) system according to an example embodiment.

FIG. 4 is a view showing a configuration of a vehicle according to an example embodiment.

FIG. 5 is a flowchart showing a method of monitoring a rear of a vehicle by an IVI system according to an example embodiment.

FIG. 6 is a view showing a vehicle according to an example embodiment.

FIG. 7 is a flowchart showing a method of monitoring a rear of a vehicle by an IVI system according to an example embodiment.

### DETAILED DESCRIPTION OF THE EMBODIMENTS

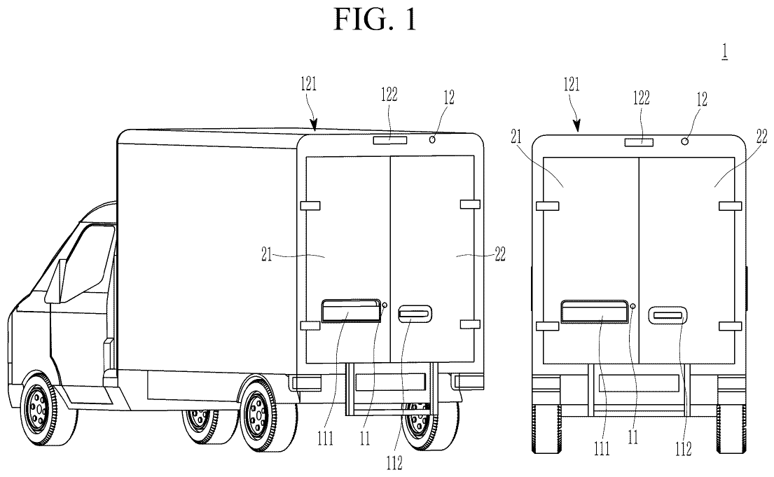

FIG. 1 shows a side perspective view of a vehicle and a rear view of the vehicle according to an example embodiment.

A vehicle 1 shown in FIG. 1 may be mounted with a twin swing door. A rear door type of the vehicle 1 that is shown in FIG. 1 is only an example for describing the present disclosure, and the present disclosure is not limited thereto. Even in the case of a rear door of a type that is different from the twin swing door type, the technical concepts of the present disclosure may be employed or applied when the vehicle is driven while its rear door is opened, which otherwise causes a restriction in acquiring a rear image. In the following description, the twin swing door is described as an example referring to the rear door.

The vehicle 1 may include a rear camera 11 providing the rear image of the vehicle 1, a built-in camera 12, twin swing doors 21 and 22, a frame 121, and a tail light 122. FIG. 1 shows that the rear camera 11 is disposed near a license plate 111 disposed on the twin swing door 21. However, the present disclosure is not limited thereto, and may be disposed near a handle 112 of the twin swing door 22. The built-in camera 12 may be disposed on the frame 121 of the twin swing doors 21 and 22 of the vehicle 1. The frame 121 is a structure for supporting the twin swing doors 21 and 22. In detail, as shown in FIG. 1, the built-in camera 12 may be disposed adjacent to the tail light 122 disposed at an upper end of the frame 121. However, the present disclosure is not limited thereto, and the built-in camera 12 may be disposed at a different location for acquiring the rear image of the area behind the vehicle 1.

The rear camera 11 may detect light incident on the rear camera 11, capture an image of a view toward or facing the rear camera 11, and generate an image signal indicating the captured image. The built-in camera 12 may be a capturing device built in the vehicle 1, detect light incident on the built-in camera 12 to capture an image of a view toward or facing the built-in camera 12, and generate an image signal indicating the captured image. While the twin swing doors 21 and 22 are closed, the rear camera 11 may face the rear of, i.e., the rear area behind the vehicle 1, and thus capture the rear view of the vehicle 1. The built-in camera 12 may face the rear of the vehicle 1, and thus capture the rear view of the vehicle 1.

The rear camera 11 may be disposed on the twin swing door 21 to provide the rear image of the vehicle 1. However, the rear camera 11 is unable to provide the rear image while the twin swing door 21 is opened. When the twin swing door 21 is opened, the image captured by the rear camera 11 may be different based on an opening degree of the twin swing door 21. In some cases, the vehicle 1 may reverse or back up while the twin swing door 21 or 22 is opened, and the rear image is thus required to be provided for safe reverse driving. For example, if the vehicle 1 is a vehicle transporting cargo, the vehicle 1 may need to reverse while the twin swing door 21 or 22 is opened for unloading the cargo. According to an example embodiment in the present disclosure, the vehicle 1 may be in reverse (i.e., reverse (R) gear) while the twin swing door 21 or 22 mounted with the rear camera 11 is opened. In this case, the vehicle 1 may acquire the rear image by using the built-in camera 12 instead of the rear camera 11, and may provide the acquired rear image through a display device of the vehicle 1. According to an example embodiment, the vehicle 1 may provide the rear image to a driver even when the twin swing door 21 or 22 is opened.

An in-vehicle infotainment (IVI) system of the vehicle 1 may control the display device to display the image provided from the built-in camera 12 instead of the rear camera 11 when both the twin swing doors 21 and 22 are opened and a gear of the vehicle 1 is shifted to the reverse gear.

When delivering goods to a destination by using the vehicle, the destination may be located in a narrow movement path such as an alley. It frequently happens that the goods are delivered to the destination after parking the vehicle in a place where its parking is possible at a short distance from the destination rather than the goods being moved by the vehicle along the narrow movement path. In this short-distance delivery, the twin swing door of the vehicle may be opened, which may cause loss or theft of an item to be delivered. In order to prevent the loss or theft when the twin swing door 21 is opened, the vehicle 1 according to an example embodiment may transmit the rear image of the vehicle 1 to a personal terminal of the driver or a monitoring device that the driver may wear. For example, when the twin swing door 21 is opened while the vehicle 1 is parked with the gear in a park (P) gear, the built-in camera 12 may capture the rear image of the vehicle 1. The vehicle 1 may transmit the image captured by the built-in camera 12 to the personal terminal or the monitoring device. In addition, the vehicle 1 may store the image captured by the built-in camera 12. In this way, in a situation where it is difficult for the rear camera 11 to normally acquire the rear image, the vehicle 1 may store the rear image acquired by the built-in camera 12 and transmit the same to the personal terminal or the like. As a result, the rear image may be monitored in real time and a black box function may be provided.

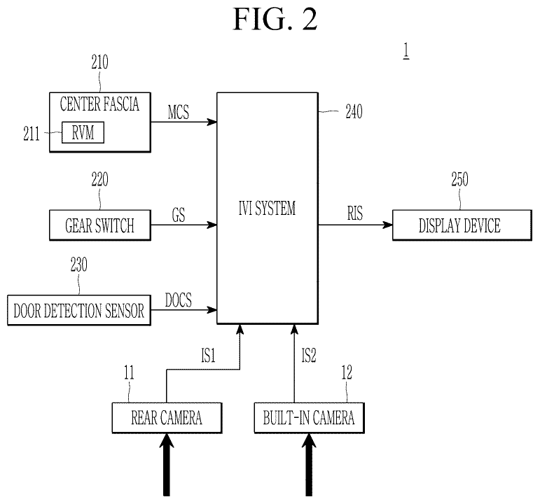

FIG. 2 is a view showing a configuration of a vehicle according to an example embodiment.

As shown in FIG. 2, the vehicle 1 may further include a center fascia 210, a gear switch 220, a door detection sensor 230, an IVI system 240, and a display device 250. For convenience of description, FIG. 2 shows the display device 250 as a component separate from the IVI system 240. However, the IVI system 240 may include the display device 250.

The center fascia 210 may include a rear view mode (RVM) switch 211 for controlling a rear view mode (RVM). In the present disclosure, the rear view mode refers to an operation mode where the IVI system 240 provides the rear view image of the vehicle. The RVM switch 211 may be implemented as a physical switch or may be displayed as an icon on a touch display when the center fascia 210 includes the touch display capable of receiving touch manipulation. When the driver manipulates the RVM switch 211 to turn on the RVM switch 211, the center fascia 210 may provide the IVI system 240 with a mode control signal (MCS) indicating that the rear view mode is on. On the contrary, when the driver manipulates the RVM switch 211 to turn off the RVM switch 211, the center fascia 210 may provide the IVI system 240 with a mode control signal (MCS) indicating that the rear view mode is off.

The gear switch 220 may be implemented for the driver to manipulate the gear shift of the vehicle 1. The gear shift may include a shift range and a gear shift step. The shift range may include the park (P) gear, a reverse (R) gear, a neutral (N) gear, a drive (D) gear, a second (2) gear, a low gear (L), or the like. The gear shift step may include a first step, a second step, a third step, a fourth step, a fifth step, or the like. For example, the gear switch 220 may indicate the shift range by the driver manipulation. The gear switch 220 may provide the IVI system 240 with a gear signal (GS) indicating the shift range determined by the driver manipulation.

The door detection sensor 230 may be a sensor that may detect the opening and closing of the twin swing door 21 or 22 (see FIG. 1) of the vehicle 1. The door detection sensor 230 may be disposed in a region where the door detection sensor 230 comes into contact with the frame 121 when the twin swing door 21 or 22 is closed and may detect a pressure change or a current change due to the opening and closing of the twin swing door 21 or 22. For example, the door detection sensor 230 may detect a relatively low pressure when the twin swing door 21 or 22 is opened compared to a pressure when the door is closed or may detect a current flowing only when the twin swing door 21 or 22 is closed. The door detection sensor 230 may generate a door opening/closing signal DOCS indicating the opening/closing of the twin swing door 21 or 22 and provide the same to the IVI system 240.

Each of the rear camera 11 and the built-in camera 12 may capture an image of a view in which the camera faces, and may each respectively generate an image signal IS1 or IS2 indicating the captured image and provide the same to the IVI system 240. Each of the rear camera 11 and the built-in camera 12 may transmit each image signal IS1 or IS2 in a frame unit to the IVI system 240 based on a predetermined transmission frequency.

The display device 250 may display a rear image signal RIS provided from the IVI system 240.

The IVI system 240 may image-process the image signal IS1 of the rear camera 11 and transmit the rear image signal RIS to the display device 250.

Image-processing refers to processing the image signal to suit the frame frequency and resolution of the display device 250. In the rear view mode, the IVI system 240 may image-process the image signal IS2 instead of the image signal IS1 based on the opening/closing status of the twin swing door 21 or 22 and the gear shift state and may provide the rear image signal RIS to the display device 250.

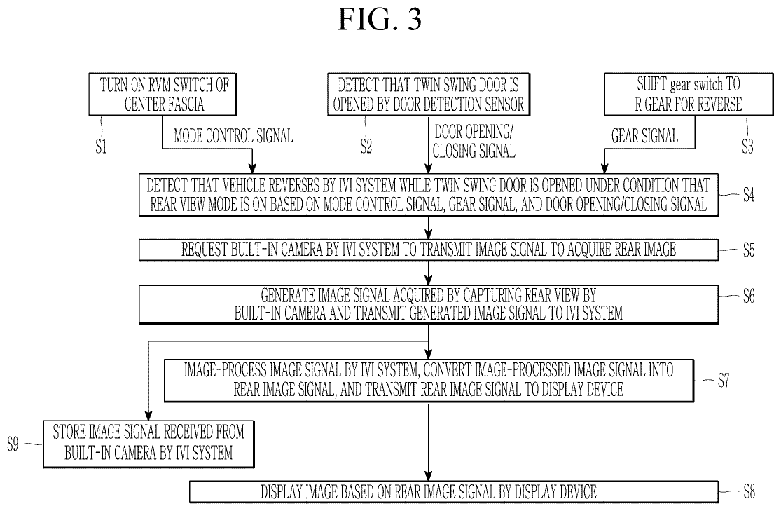

Hereinafter, referring to FIG. 3, a method of providing a rear image by an IVI system is shown when a vehicle reverses or back up while the twin swing door is opened.

FIG. 3 is a flowchart showing the method of providing the rear image by the IVI system according to an example embodiment.

The RVM switch 211 of the center fascia 210 may be turned on by the driver manipulation (S1). The center fascia 210 may transmit, to the IVI system 240, the mode control signal MCS indicating that the rear view mode is on.

The door detection sensor 230 may detect that the twin swing door 21 or 22 is opened (S2). The door detection sensor 230 may transmit, to the IVI system 240, the door opening/closing signal DOCS indicating that the twin swing door 21 or 22 is opened.

The gear switch 220 may be shifted to the R gear for reverse by driver manipulation (S3). The gear switch 220 may transmit the gear signal GS indicating the reverse R gear to the IVI system 240.

The IVI system 240 may detect that the vehicle 1 reverses or backs up while the twin swing door 21 or 22 is opened under a condition that the rear view mode is on, based on the mode control signal MCS, the gear signal GS, and the door opening/closing signal DOCS (S4). Hereinafter, a state where the rear view mode is on, the twin swing door 21 or 22 is opened, and the gear shift is in reverse (R) gear is referred to as a “reverse open state”. The reverse open state may not be achieved when the twin swing door 21 or 22 is closed even though the rear view mode is on and the gear switch 220 is in the reverse R gear. The reverse open state may not be achieved when the gear switch 220 is not in the reverse R gear even while the twin swing door 21 or 22 is opened under the condition that the rear view mode is on. The reverse open state may not be achieved while both the rear views are off even while the twin swing door 21 or 22 is opened and the gear switch 220 is in the reverse R gear.

If the IVI system 240 detects the rear open state at step S4, the IVI system 240 may determine to acquire the rear image from the built-in camera 12 instead of the rear camera 11, and request the built-in camera 12 to transmit the image signal (S5).

The built-in camera 12 may capture the rear view in response to the request from the IVI system 240 to generate the image signal IS2 indicating the captured image and may transmit the same to the IVI system 240 (S6).

The IVI system 240 may image-process the received image signal IS2, convert the same into the rear image signal RIS, and transmit the same to the display device 250 (S7).

The display device 250 may display the image based on the rear image signal RIS (S8).

The IVI system 240 may store the image signal IS2 received from the built-in camera 12 in the reverse open state (S9). This configuration is for recording the image, which is an original purpose of the built-in camera 12. The driver may view the image in the reverse open state through the display device 250 by using the stored image signal IS2 when necessary.

In this way, the IVI system 240 may provide the rear image to the driver through the display device 250 even though the driver does not reproduce the image acquired by the built-in camera 12 in the reverse open state.

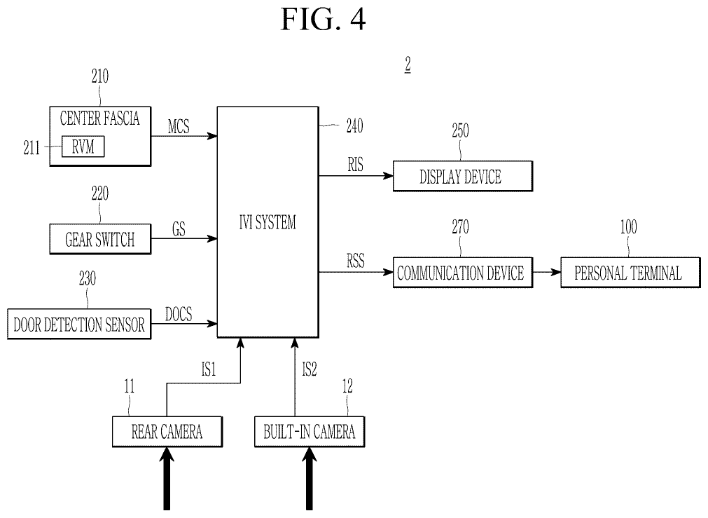

FIG. 4 is a view showing a configuration of a vehicle according to an example embodiment.

A vehicle 2 shown in FIG. 4 may further include a communication device 270 compared to the vehicle 1 shown in FIG. 2. The remaining configurations shown in FIG. 4 are the same as the corresponding configurations shown in FIG. 2.

As shown in FIG. 4, the vehicle 2 may further include the communication device 270. In the rear monitor state, the IVI system 240 may image-process the image signal IS2 captured and generated by the built-in camera 12 to thus generate a rear surveillance image signal RSS. The IVI system 240 may provide the rear surveillance image signal RSS to the communication device 270 and the communication device 270 may transmit the rear surveillance image signal RSS to a personal terminal 100 of the driver of the vehicle 2.

The rear monitor state refers to a state where the rear view mode is on, the twin swing door 21 or 22 is opened, the vehicle 2 is parked, and the gear switch 220 is in the park (P) or neutral (N) gear. An item stored in the vehicle 2 may be stolen or damaged when the driver leaves the vehicle 2 to deliver the item while vehicle 2 is parked. To prevent this problem, it is advantageous to provide the rear view of the area behind the vehicle 2 to the driver that is leaving the vehicle 2. It is possible to prevent the items stored in the vehicle 2 from being stolen or damaged if the driver may monitor whether anyone is approaching the vehicle 2 from the rear while the twin swing door 21 or 22 is opened.

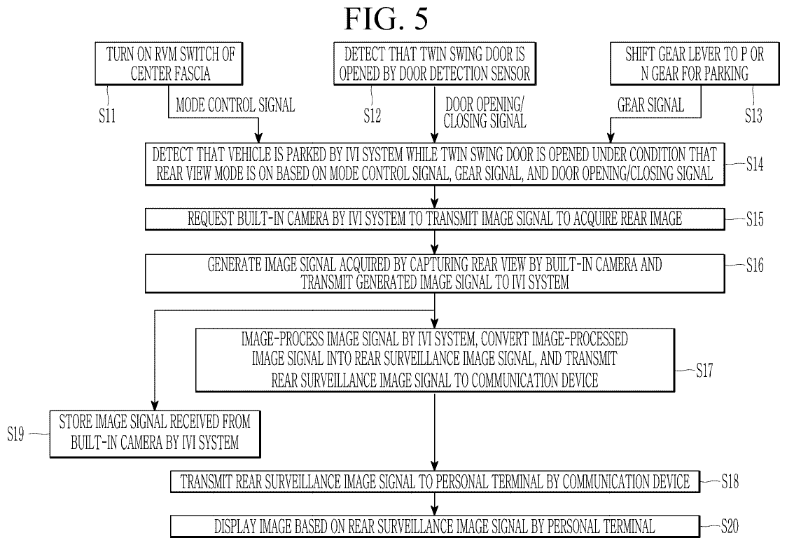

FIG. 5 is a flowchart showing a method of monitoring a rear of a vehicle by an IVI system according to an example embodiment.

The RVM switch 211 of the center fascia 210 may be turned on by driver manipulation (S11). The center fascia 210 may transmit, to the IVI system 240, the mode control signal MCS indicating that the rear view mode is on.

The door detection sensor 230 may detect that the twin swing door 21 or 22 is opened (S12). The door detection sensor 230 may transmit, to the IVI system 240, the door opening/closing signal DOCS indicating that the twin swing door 21 or 22 is opened.

The gear switch 220 may be shifted to the P or N gear for parking by driver manipulation (S13). The gear switch 220 may transmit the gear signal GS indicating the P or N gear to the IVI system 240.

The IVI system 240 may detect that the vehicle 2 is parked while the twin swing door 21 or 22 is opened under the condition that the rear view mode is on, based on the mode control signal MCS, the gear signal GS, and the door opening/closing signal DOCS (S14).

If the IVI system 240 detects the rear monitor state at step S14, the IVI system 240 may determine to acquire the rear image from the built-in camera 12 instead of the rear camera 11 and may request the built-in camera 12 to transmit the image signal (S15).

The built-in camera 12 may capture the rear view in response to the request from the IVI system 240 to generate the image signal IS2 indicating the captured image and may transmit the same to the IVI system 240 (S16).

The IVI system 240 may image-process the received image signal IS2, convert the same into the rear surveillance image signal RSS, and transmit the same to the communication device 270 (S17). Here, image-processing refers to converting the image signal IS2 into a signal that may be transmitted to the personal terminal 100 and displayed.

The communication device 270 may transmit the rear surveillance image signal RSS to the personal terminal 100 (S18).

The IVI system 240 may store the image signal IS2 received from the built-in camera 12 in the rear monitor state (S19). This configuration is for recording the image, which is the original purpose of the built-in camera 12. The driver may view the image in the rear monitor state through the display device 250 by using the stored image signal IS2 when necessary.

The personal terminal 100 may receive the rear surveillance image signal RSS, and display the image based on the rear surveillance image signal RSS (S20).

In this way, while the twin swing door 21 is opened, the IVI system 240 may prevent the items from being stolen or damaged by providing the rear image to the driver, not only when the vehicle reverses or backs up, but also when the vehicle is parked.

The vehicles according to the previous embodiments may include the rear camera, and some vehicles may only include the built-in camera. In such a vehicle, the built-in camera may provide the function of the rear camera. In the vehicle only including the built-in camera, the IVI system may be operated in a case of the reverse open state as in the embodiment according to the flowchart previously shown in the FIG. 3. Furthermore, if the gear shift is in reverse (R), the built-in camera may provide the rear image to the IVI system, as in the reverse open state of the previous embodiment, even when the twin swing door is closed.

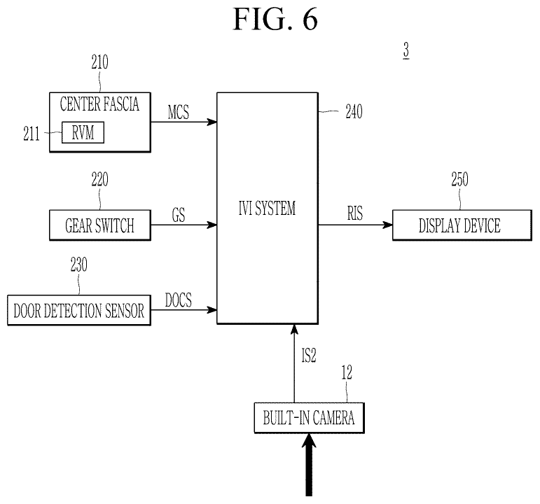

FIG. 6 is a view showing a vehicle according to an example embodiment.

As shown in FIG. 6, a vehicle 3 may not include the rear camera compared to the vehicle 1 or the vehicle 2. The remaining configurations are the same as those described above, and their descriptions are thus omitted below.

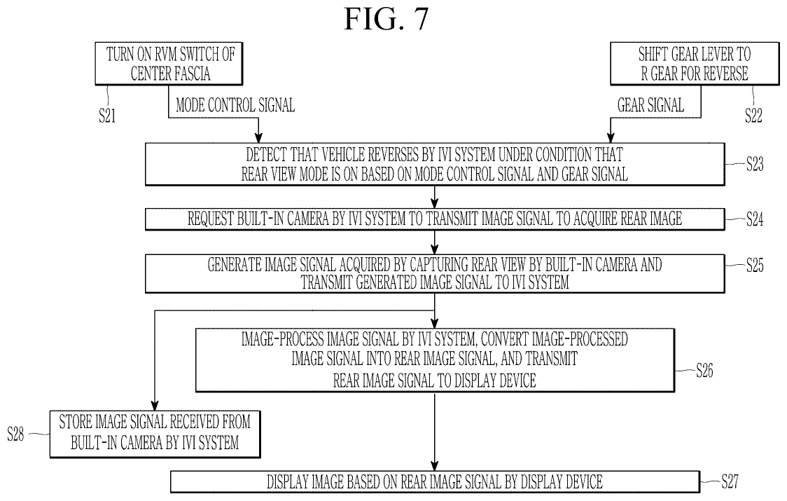

FIG. 7 is a flowchart showing a method of monitoring a rear of a vehicle by an IVI system according to an example embodiment.

The RVM switch 211 of the center fascia 210 may be turned on by driver manipulation (S21). The center fascia 210 may transmit, to the IVI system 240, the mode control signal MCS indicating that the rear view mode is on.

The gear switch 220 may be shifted to the R gear for reverse by driver manipulation (S22). The gear switch 220 may transmit the gear signal GS indicating the reverse R gear to the IVI system 240.

The IVI system 240 may detect that the vehicle 1 reverses under the condition that the rear view mode is on based on the mode control signal MCS and the gear signal GS (S23).

If the IVI system 240 detects that the vehicle 3 reverses or backs up at step S23, the IVI system 240 may determine to acquire the rear image from the built-in camera 12 and may request the built-in camera 12 to transmit the image signal (S24).

The built-in camera 12 may capture the rear view in response to the request from the IVI system 240 to generate the image signal IS2 indicating the captured image and may transmit the same to the IVI system 240 (S25).

The IVI system 240 may image-process the received image signal IS2, convert the same into the rear image signal RIS, and transmit the same to the display device 250 (S26).

The display device 250 may display the image based on the rear image signal RIS (S27).

The IVI system 240 may store the image signal IS2 received from the built-in camera 12 in a reverse state (S28). This configuration is for recording the image, which is the original purpose of the built-in camera 12. The driver may view the image in the reverse state through the display device 250 by using the stored image signal IS2 when necessary.

The method of monitoring the rear of a vehicle by an IVI system described with reference to FIG. 5 may also be applied to the vehicle 3 only including the built-in camera.

According to the above-described embodiments, the image acquired by the built-in camera may be used not only for recording/storage purposes, but also may be provided as the rear image when the rear image is unable to be acquired from the rear camera or the rear camera is not provided in the vehicle.

In the vehicle of the twin swing door type, the rear camera may capture the image of a place other than the rear area behind the vehicle when the rear camera is mounted on the license plate or handle, and the vehicle reverses or backs up while the door is opened. In this case, the rear image is unable to be provided to the driver. A special vehicle having a special purpose such as a police operation vehicle, a delivery vehicle, or a refrigerated truck may reverse while its rear door is opened. When the vehicle having a great height reverses of backs up, the rear image may be highly beneficial or required. Therefore, according to the embodiments, the image signal may be received from the built-in camera to thus provide the rear image when the rear camera is unable to perform its intended function, or when the rear camera is not provided in the vehicle.

When a component, controller, system, module, unit, device, element, or the like (i.e., a system) of the present disclosure is described as having a purpose or performing an operation, function, or the like, the component, controller, system, module, unit, device, element, or the like should be considered herein as being “configured to” meet that purpose or to perform that operation or function. Each component, controller, system, module, unit, device, element, and the like may separately embody or be included with a processor and a memory, such as a non-transitory computer readable media, as part of the system.

Although the embodiments of the present disclosure have been described in detail hereinabove, the scope of the present disclosure is not limited thereto, and several modifications and alterations made by those of ordinary skill in the art using a basic concept of the present disclosure as defined in the claims may also fall within the scope of the present disclosure.

What is claimed is:

1. A vehicle comprising:
a rear door configured to selectively open and close a rear part of the vehicle;
a gear switch configured to manipulate a gear shift of the vehicle;
a built-in camera disposed on a frame supporting the rear door and implemented to capture a rear view behind the vehicle;
an in-vehicle infotainment (IVI) system configured to receive an image signal acquired by capturing the rear view of the vehicle from the built-in camera based on at least one of a state of a shift range indicated by the gear switch and an open or closed state of the rear door when a rear view mode is on; and
a display device configured to display a rear image signal provided from the IVI system,
wherein the rear view mode is an operation mode where the IVI system provides a rear view image of the vehicle.

2. The vehicle of claim 1, wherein, in a reverse open state in which the rear view mode is on, the gear switch indicates the shift range in reverse, and the rear door is in the open state, the IVI system receives the image signal acquired by capturing the rear view of the vehicle from the built-in camera and generates the rear image signal by using the image signal.

3. The vehicle of claim 2, further comprising:
a rear camera disposed at the rear door,
wherein, in the reverse open state,
the IVI system requests the built-in camera instead of the rear camera to transmit the image signal, and
the built-in camera captures the rear view behind the vehicle in response to the request to generate the image signal and transmits the generated image signal to the IVI system.

4. The vehicle of claim 1, wherein, in a rear monitor state in which the rear view mode is on, the gear switch indicates the shift range is in a park or neutral gear, and the rear door is opened, the IVI system receives the image signal acquired by capturing the rear view of the vehicle from the built-in camera and generates the rear image signal by using the image signal.

5. The vehicle of claim 4, further comprising:
a communication device configured to receive the rear image signal from the IVI system and to transmit the rear image signal to a personal terminal of a vehicle driver.

6. The vehicle of claim 1, wherein, when the rear view mode is on and the gear switch indicates the shift range in reverse, the IVI system receives the image signal acquired by capturing the rear view of the vehicle from the built-in camera and generates the rear image signal by using the image signal.

7. The vehicle of claim 1, further comprising:
a center fascia including a switch for controlling the rear view mode.

8. A method of monitoring a rear view behind a vehicle by an in-vehicle infotainment (IVI) system of the vehicle, the method comprising:
transmitting, by a center fascia of the vehicle, a mode control signal to the IVI system indicating that a rear view mode is on;
transmitting, by a door detection sensor, a door opening/closing signal to the IVI system by detecting that a rear door of the vehicle is opened;
transmitting, by a gear switch of the vehicle, a gear signal to the IVI system indicating a shift range in reverse;
detecting, by the IVI system, a reverse open state in which the vehicle reverses while the rear door is opened under a condition that the rear view mode is on, based on the mode control signal, the gear signal, and the door opening/closing signal;
requesting, by the IVI system, a built-in camera of the vehicle to transmit an image signal when the reverse open state is detected; and
generating, by the built-in camera of the vehicle, the image signal indicating an image acquired by capturing the rear view behind the vehicle in response to the request and transmitting the generated image signal to the IVI system.

9. The method of claim 8, further comprising:
receiving, by the IVI system, the image signal and converting the received image signal into a rear image signal by image-processing the signal; and
displaying, by a display device of the vehicle, the rear image signal.

10. A method of monitoring a rear view behind a vehicle by an in-vehicle infotainment (IVI) system of the vehicle, the method comprising:
transmitting, by a center fascia of the vehicle, a mode control signal to the IVI system indicating that a rear view mode is on;
transmitting, by a door detection sensor, a door opening/closing signal to the IVI system by detecting that a rear door of the vehicle is opened;
transmitting, by a gear switch of the vehicle, a gear signal to the IVI system indicating a shift range in a park gear;
detecting, by the IVI system, a rear monitor state in which the vehicle is parked while the rear door is opened under a condition that the rear view mode is on, based on the mode control signal, the gear signal, and the door opening/closing signal;
requesting, by the IVI system, a built-in camera of the vehicle to transmit an image signal when the rear monitor state is detected; and
generating, by the built-in camera of the vehicle, the image signal indicating an image acquired by capturing a rear view of the vehicle in response to the request and transmitting the generated image signal to the IVI system.

11. The method of claim 10, further comprising:
receiving, by the IVI system, the image signal and converting the received image signal into a rear image signal by image-processing the signal; and
transmitting, by a communication device of the vehicle, the rear image signal to a personal terminal of a driver or occupant of the vehicle.
